(19) United States
(12) Patent Application Publication
(10) Pub. No.: US 2026/0011034 A1
(43) Pub. Date: Jan. 8, 2026

(54) SYSTEM, CALIBRATION APPARATUS AND METHOD FOR DETERMINING A FIRST TRANSFORMATION FOR TWO CAMERAS

(71) Applicant: Topgolf Sweden AB, Danderyd (SE)

(72) Inventors: Lars Nyhed, Täby (SE); Ludvig Kindberg, Solna (SE); Kristoffer Uggla Lingvall, Solna (SE)

(21) Appl. No.: 19/255,765

(22) Filed: Jun. 30, 2025

(30) Foreign Application Priority Data
Jul. 2, 2024 (SE) 2450746-9

(51) Int. Cl. G06T 7/80; G06T 7/20; G06T 7/50; H04N 17/00

(52) U.S. Cl. CPC G06T 7/85; G06T 7/20; G06T 7/50; H04N 17/002; G06T 2207/10016; G06T 2207/30204; G06T 2207/30224; G06T 2207/30241

(57) ABSTRACT

A system, a method and a calibration apparatus determine a first transformation between a first coordinate system of a first camera and a second coordinate system of a second camera by use of a third camera. The third camera captures first and second markers in its field of view. The calibration apparatus iteratively determines updated orientation components of a third transformation, between the first and third cameras. In a similar manner, the calibration apparatus iteratively determines updated orientation and translation components for a second transformation, between the first and second cameras. Furthermore, the calibration apparatus iteratively determines at least updated orientation components for the first transformation.

### CROSS-REFERENCE TO RELATED APPLICATIONS

This application claims the benefit of priority of Swedish Patent Application No. 2450746-9, entitled “SYSTEM, CALIBRATION APPARATUS AND METHOD FOR DETERMINING A FIRST TRANSFORMATION FOR TWO CAMERAS”, filed 2 Jul. 2024.

### TECHNICAL FIELD

The embodiments herein relate to calibration of two cameras, having at least partially overlapping fields of view. In particular, a method and a calibration apparatus for determining a first transformation between a first coordinate system of a first camera and a second coordinate system of a second camera are disclosed. A corresponding computer program and a carrier therefor as well as a related system are also disclosed.

### BACKGROUND

When tracking sports projectiles, such as golf balls, a tracking sensor is used to capture the sports projectile's trajectory as it is moving.

In some scenarios, a broadcast camera for broadcasting a video showing the sport projectile is also used. The tracked trace from the tracking sensor is then rendered in the video to enhance the experience for viewers of the video. In order to do this, the tracked trace must be converted, or transformed, from a coordinate system of the tracking sensor to a coordinate system of the broadcast camera. Thus, there is a need for calibration of the tracking sensor and the broadcast camera.

Related literature discloses a variety of methods for stereo camera calibration, such as the 8-point algorithm: https://en.wikipedia.org/wiki/Eight-point_algorithm. In common for many methods described in the literature is a need for having a relatively large distance between the tracking camera and the broadcast camera and accurately measured positions of numerus reference markers, such as a checkboards, markers or other district points that are visible in both cameras.

In the case of broadcast golf, there are no or limited possibilities to add items such as markers, flags, stickers, chessboards, signs or any kind of external reference points, visible to the broadcast camera. Also, it is not possible to establish a wide base between the cameras, given the geometrical limitation of a tee box and the distance to far end of a golf ball trajectory, typically over 200 meters.

When arbitrary placement of the broadcast camera and the tracking sensor occurs at a golf tee box, the coordinate systems of the broadcast camera and the tracking sensor, respectively, have no visible fixed points in the real world. The camera's coordinate-axes have no representation and are of course invisible in the golf course environment. Thus, orientation and translation transformations cannot be directly observed or measured.

### SUMMARY

An object may be to overcome, or at least reduce, one or more of the abovementioned problems and/or disadvantages.

This, and other objects, may be achieved by the solutions set forth in the appended independent claims.

According to an aspect, the object is achieved by a method, performed by a calibration apparatus, for determining a first transformation between a first coordinate system of a first camera and a second coordinate system of a second camera. The first and second cameras are spaced away from each other and located above a ground plane. A first field of view of the first camera at least partially overlaps with a second field of view of the second camera. A third camera has a third field of view partially overlapping with the first and second fields of view. The third camera's position and the first camera's position are approximated to be equal. A distant object is present in the first, second and third fields of view and located at an object distance from a location at at least one of the first camera, the second camera, and the third camera, preferably at the first camera. A first marker and a second marker are located at the ground plane and the first and second markers are visible in the second and third fields of view. A second transformation refers to transformation between the second coordinate system of the second camera and a third coordinate system of the third camera. A third transformation refers to transformation between the first coordinate system of the first camera and the third coordinate system of the third camera. The first camera has a first focal length. A first measure indicates a first distance, projected on the ground plane, between the first marker and at least one of the first camera and the third camera. A second measure indicates a second distance, projected on the ground plane, between the second marker and at least one of the first camera and the third camera. A third measure indicates a third distance, projected on the ground plane, between the second camera and at least one of the first camera and the third camera. A fourth measure indicates a fourth distance, projected on the ground plane, between the second camera and the first marker. A fifth measure indicates a fifth distance, projected on the ground plane, between the second camera and the second marker. A sixth measure indicates a sixth distance, projected on the ground plane, between the first marker and the second marker. A seventh measure indicates a seventh distance indicating difference in height between the second camera and at least one of the first and third cameras. A first angle measure indicates a feature angle identified in a first image plane representing the first field of view. A second angle measure indicates the feature angle identified in a second image plane representing the second field of view. A third angle measure indicates the feature angle identified in a third image plane representing the third field of view.

The calibration apparatus estimates a third focal length of the third camera based on
the first measure,
the second measure,
a third position of the first marker in the third field of view,
a fourth position of the second marker in the third field of view,
the sixth measure, and
an image resolution of the third camera.

The calibration apparatus estimates initial orientation components of the third transformation based on
the distant object's position in the first camera,
an image resolution of the first camera,
the first focal length,
the distant object's position in the third camera,
the image resolution of the third camera,
the third focal length,
the object distance,
the first angle measure, and
the third angle measure.

The calibration apparatus estimates initial translation components of the third transformation to be zero.

The calibration apparatus iteratively determines updated orientation components of the third transformation and an updated third focal length under a third constraint that a third reprojection error for at least one reprojection point in the first and third fields of view satisfies a third condition for allowed reprojection error.

The calibration apparatus estimates a second focal length of the second camera based on
the fourth measure,
the fifth measure,
a first position of the first marker in the second field of view,
a second position of the second marker in the second field of view,
the sixth measure, and an image resolution of the second camera.

The calibration apparatus estimates initial orientation components of the second transformation based on
the distant object's position in the second camera,
an image resolution of the second camera,
the second focal length, and
the distant object's position in the third camera,
an image resolution of the third camera,
the third focal length,
the object distance,
the third measure,
the seventh measure,
the second angle measure, and
the third angle measure.

The calibration apparatus estimates initial second translation components of the second transformation based on
the third measure defining a radius of an imaginary circle centered at camera B,
the second measure defining a radius of an imaginary circle centered at the second marker L,
the fifth measure, and
the seventh measure.

The calibration apparatus iteratively determines updated orientation and translation components for the second transformation and an updated second focal length under a second constraint that a second reprojection error for at least one reprojection point in the second and third fields of view satisfies a second condition for allowed reprojection error.

The calibration apparatus estimates initial first orientation components for the first transformation based on the updated second orientation components and the updated third orientation components.

The calibration apparatus estimates initial translation components for the first transformation based on the updated second translation components.

The calibration apparatus iteratively determines at least updated orientation components for the first transformation and a further updated second focal length under a first constraint that a first reprojection error for at least one reprojection point in the first and second fields of view satisfies a first condition for allowed reprojection error.

Thanks to the third camera, it is made possible to relax requirements concerning the first camera. The requirement can be that the first and second markers should be visible is in first camera, e.g., to improve accuracy of a transformation between the first and second camera. Hence, with the introduction of the third camera, which is positioned at the position of the first camera and which is required to capture the first and second markers in its field of view, the requirement that the first camera should capture the first and second markers can be relaxed, or dispensed with. The first camera can therefore more freely capture what is most interesting and/or appealing to a viewer of the video from the first camera. Therefore, user of the first camera is made easier, i.e., less requirements to fulfill for an operator of the first camera, and the viewer experience can therefore be improved. These advantages are achieved thanks to that an accurate first transformation can be determined while using the third camera, and the second and third transformations as described herein.

According to another aspect, the object is achieved by a calibration apparatus configured for determining a first transformation between a first coordinate system of a first camera and a second coordinate system of a second camera. The first and second cameras are spaced away from each other and located above a ground plane. A first field of view of the first camera at least partially overlaps with a second field of view of the second camera. A third camera has a third field of view partially overlapping with the first and second fields of view. The third camera's position and the first camera's position are approximated to be equal. A distant object is present in the first, second and third fields of view and located at an object distance from a location at at least one of the first camera, the second camera, and the third camera, preferably at the first camera. A first marker and a second marker are located at the ground plane and the first and second markers are visible in the second and third fields of view. A second transformation refers to transformation between the second coordinate system of the second camera and a third coordinate system of the third camera. A third transformation refers to transformation between the first coordinate system of the first camera and the third coordinate system of the third camera. The first camera has a first focal length. A first measure indicates a first distance, projected on the ground plane, between the first marker and at least one of the first camera and the third camera. A second measure indicates a second distance, projected on the ground plane, between the second marker and at least one of the first camera and the third camera. A third measure indicates a third distance, projected on the ground plane, between the second camera and at least one of the first camera and the third camera. A fourth measure indicates a fourth distance, projected on the ground plane, between the second camera and the first marker. A fifth measure indicates a fifth distance, projected on the ground plane, between the second camera and the second marker. A sixth measure indicates a sixth distance, projected on the ground plane, between the first marker and the second marker. A seventh measure indicates a seventh distance indicating difference in height between the second camera and at least one of the first and third cameras. A first angle measure indicates a feature angle identified in a first image plane representing the first field of view. A second angle measure indicates the feature angle identified in a second image plane representing the second field of view. A third angle measure indicates the feature angle identified in a third image plane representing the third field of view. The calibration apparatus is configured for:
The calibration apparatus is configured for estimating a third focal length of the third camera based on
the first measure,
the second measure,
a third position of the first marker in the third field of view,
a fourth position of the second marker in the third field of view,
the sixth measure, and
an image resolution of the third camera.

The calibration apparatus is configured for estimating initial orientation components of the third transformation based on
the distant object's position in the first camera,
an image resolution of the first camera,
the first focal length,
the distant object's position in the third camera,
the image resolution of the third camera,
the third focal length,
the object distance,
the first angle measure, and
the third angle measure.

The calibration apparatus is configured for estimating initial translation components of the third transformation to be zero.

The calibration apparatus is configured for iteratively determining updated orientation components of the third transformation and an updated third focal length under a third constraint that a third reprojection error for at least one reprojection point in the first and third fields of view satisfies a third condition for allowed reprojection error.

The calibration apparatus is configured for estimating a second focal length of the second camera based on
the fourth measure,
the fifth measure,
a first position of the first marker in the second field of view,
a second position of the second marker in the second field of view,
the sixth measure, and
an image resolution of the second camera.

The calibration apparatus is configured for estimating initial orientation components of the second transformation based on
the distant object's position in the second camera,
an image resolution of the second camera,
the second focal length, and
the distant object's position in the third camera,
an image resolution of the third camera,
the third focal length,
the object distance,
the third measure,
the seventh measure,
the second angle measure, and
the third angle measure.

The calibration apparatus is configured for estimating initial second translation components of the second transformation based on
the third measure defining a radius of an imaginary circle centered at camera B,
the second measure defining a radius of an imaginary circle centered at the second marker L,
the fifth measure, and
the seventh measure.

The calibration apparatus is configured for iteratively determining updated orientation and translation components for the second transformation and an updated second focal length under a second constraint that a second reprojection error for at least one reprojection point in the second and third fields of view satisfies a second condition for allowed reprojection error.

The calibration apparatus is configured for estimating initial first orientation components for the first transformation based on the updated second orientation components and the updated third orientation components.

The calibration apparatus is configured for estimating initial translation components for the first transformation based on the updated second translation components.

The calibration apparatus is configured for iteratively determining at least updated orientation components for the first transformation and a further updated second focal length under a first constraint that a first reprojection error for at least one reprojection point in the first and second fields of view satisfies a first condition for allowed reprojection error.

According to further aspect, the object is achieved by a computer program and a computer program carrier corresponding to the aspects above.

### BRIEF DESCRIPTION OF THE DRAWINGS

FIG. 1 is an overview of an example of a system according to some embodiments herein.

FIG. 2a and FIG. 2b are side views of the first and second cameras, respectively, of the system according to some embodiments herein.

FIG. 3 is a flowchart illustrating the method according to some embodiments herein.

FIG. 4 is a top view of the cameras in FIG. 1.

FIG. 5a and FIG. 5b are further top views illustrating angles and distance in relation to two cameras.

FIG. 6 is an illustration of how to obtain estimations of two translation components.

FIG. 7 includes two side views illustrating how to obtain an estimate of an orientation component.

FIG. 8 is a side view of the cameras in FIG. 1.

FIG. 9 is a block diagram illustrating an example of the calibration apparatus according to some embodiments herein.

### DETAILED DESCRIPTION

In the following description, the same, or similar, reference numerals have been used to denote the same, or similar, features, examples, items, elements or the like, when applicable.

As used herein, the expression “coordinate system of a camera” may refer to that the camera's field of view is associated with, such as aligned with, corresponding to, or the like, a coordinate system, such as in three dimensions. For example, the coordinate system may describe a position of the camera and/or a rotation of the camera along three spatial dimensions, x (width), y (height) and z (length/depth).

As used herein, the expression “transformation”, or “coordinate transformation”, refers a transformation of orientation and/or translation components between one coordinate system of one camera and another coordinate system of another camera. The transformation can apply for transformation from said one camera to said another camera, and an inverse transformation can be obtained mathematically for transformation from said another camera to said one camera. Orientation component can sometimes be referred to as rotation component.

As used herein, the expression “image resolution of a camera” refers to a two-dimensional image resolution of the camera, such as a first number of pixels by a second number of pixels, 640×480, 1600×1280, etc.

As used herein, the term “marker” may refer to a tee marker, a corner of tee box, an identification post for marking the tee, or the like.

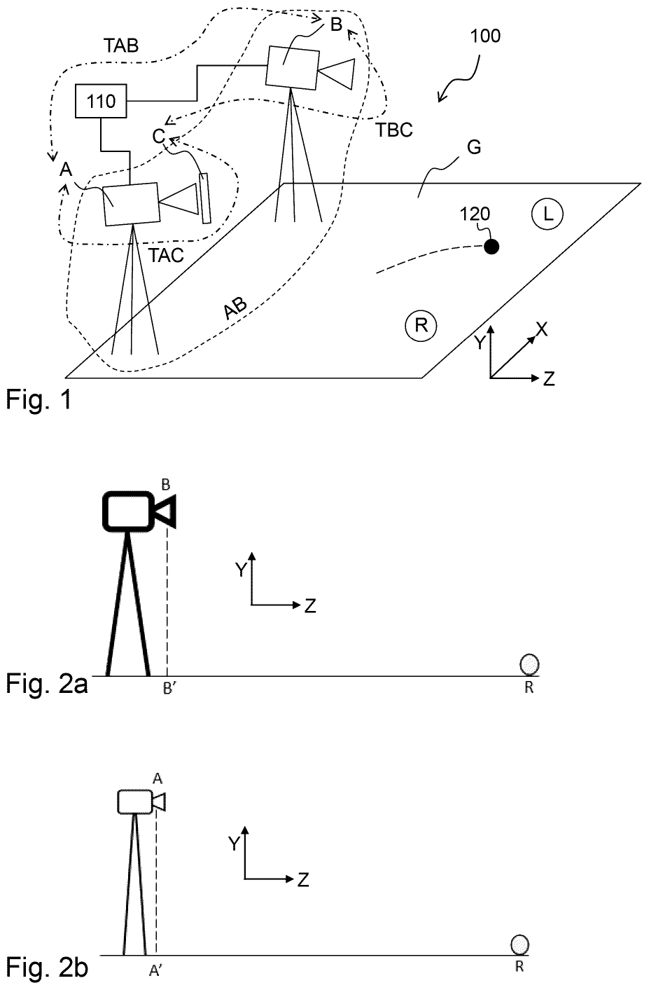

FIG. 1, FIG. 2a and FIG. 2b illustrate an exemplifying set up of a system 100 configured to perform the methods described herein.

The system 100 includes a first camera A, such as a tracking sensor, or the like, and a second camera B, such as a broadcast camera, a video camera or the like. The tracking sensor can include a video camera and optionally a radar, which then can be fixedly mounted relatively each other.

The system 100 further includes a calibration apparatus 110, such as a calibration device, a computer, a computer function, a cloud function, a serverless backend function, an image processing device, a processing module or the like. The calibration apparatus 110 may be separated, but connected to, the first and second cameras A, B. In some examples, the calibration apparatus 110 can be realized as a computer function residing and executable in a cloud, such as a virtual and/or physical computer in a data center or the like. In some examples, the calibration apparatus 110 can be built into at least one of the first and second cameras A, B. Further, the calibration apparatus 110 may be realized as a separate physical entity in the form of a calibration device.

In the examples herein, the calibration apparatus 110 is configured to be connectable to the first and second camera A, B for transferring of information, such as images, distance information, angle information, instructions, blob information, trace information, tracking stream(s), messages, or the like, to/from the first and second cameras A, B.

The first and second cameras A, B may be located spaced away from each other, e.g., at a distance from each other. As shown in FIG. 1, the first and second cameras A, B can be spaced away from, such as standing on, hanging over, laying on, or the like, a ground plane G, e.g., on the same side of the ground plane G. A respective optical center of each of the first and second cameras A, B is located at a distance from the ground plane G. The ground plane G may be defined by an x-axis and a z-axis as shown in FIG. 1. A y-axis is shown perpendicularly to the x-axis and the z-axis. The y-axis represents height, the x-axis represents width, and the z-axis represents depth, or distance, e.g., in the camera's viewing direction or in the main direction of a movement of the sports projectile, such as a golf ball, or the like.

A first field of view of the first camera A at least partially overlaps with a second field of view of the second camera B. A distant object P, shown in FIG. 8, is present in both the first and second fields of view. Furthermore, a first marker R and a second marker L are visible in the second field of view, e.g., at least the second field of view. The first marker R and the second marker L may thus be visible in the first field of view, but not necessarily. Generally, the first and second marker R, L can be so called tee markers that are commonly used on a golfing area, such as a golf course, a driving range or the like, to indicate a tee, from which golf balls can be shot by a player. The first marker R can be a right tee marker and the second marker L can be a left tee marker. In some examples, the first and second marker R, L can be a front, right corner and a front, left corner of a bounding box that indicates the tee.

For golf tracing purposes, a method to calibrate a tracking sensor and a broadcast camera without adding any reference items, such as reference markings at known positions, to the golf course environment is provided. Reference items can in this context refer to any aid that is placed in the golf course environment for the purpose, e.g., only purpose, of calibration, or at least not for the purpose of playing golf. With the method herein, a first transformation between a first camera, such as a tracking camera, and a second camera, such as a broadcast camera, is estimated. Thereby, a golf ball tracking sensor can be placed at an arbitrary position on the tee box, well separated from the broadcast camera. The solution may benefit from using a measuring tape, a plumb bob, a laser distance measurement device, a laser range finder, and/or the like. It may be preferred that both tee markers, referred to as a first and second marker herein, are visible in the image of the second camera. Notably, the first and second markers are part of the golf course environment for playing purposes. The embodiments herein thus advantageously use the already existing first and second markers.

It may be noted that the following notations are used herein:
tX: three-dimensional (x,y,z) position/translation of one camera in the coordinate system of another camera. In more detail, a first translation component is denoted tX.x, a second translation component is denoted tX.z, and a third translation component is denoted tX.y. E.g., t1 for the translation components of the first transformation, t2 for the translation components of the second transformation, and t3 for the translation components of the third transformation.
rX: three-dimensional (x,y,z) orientation (rotation along the x,y and z axis) of one camera in the coordinate system of another camera. In more detail, a first orientation component is denoted rX.x, a second orientation component is denoted rX.y, and a third orientation component is denoted rx.z. E.g., r1 for the orientation components of the first transformation, r2 for the orientation components of the second transformation, and r3 for the orientation components of the third transformation.
f: focal length of a camera.
f′: the distance, in millimeters, between the focal point of the lens and the image sensor at a given zoom level and focus level (when a lens is focused at infinity f′ is equal to the focal length of the lens/camera f). f′a is a known focal length of the first camera A.
f′b: estimated focal length of the second camera B.
f′c: estimated focal length of the third camera C.
p′: two-dimensional (x,y) position in a camera's image plane.
Cs: two-dimensional (x,y) sensor size (cs) in millimeters of a camera (csa for a first camera A, csb for a second camera B, and csc for a third camera C).
Res: two-dimensional (x,y) image resolution in pixels of a camera (res for a Camera A or a Camera B is denoted resa and resb respectively, and for the third camera C resc).
Camera A: a first camera, such as a tracking camera.
Camera B: a second camera, such as the broadcast camera.
Camera C: a third camera, such as a still image digital camera, a camera of a smartphone, a camera of a tablet PC, or the like.
fn( . . . ): A combination of various well-known mathematical functions, trigonometric functions, geometric rules and/or formulas and/or theorems, and/or the like, such as tangent, sinus, cosine, arcus tangent, arcus sinus, arcus cosine, squared root, Pythagoras theorem, triangle conformity etc. n denotes a counter used to indicate that this function may be different from one or more of the other functions disclosed herein.
P A distinct object far away visible in cameras A, B, and C.

For the purposes of the method herein, for the first camera A, f is considered to be constant and known and f′, e.g., denoted f′a, is assumed to be approximately equal to f.

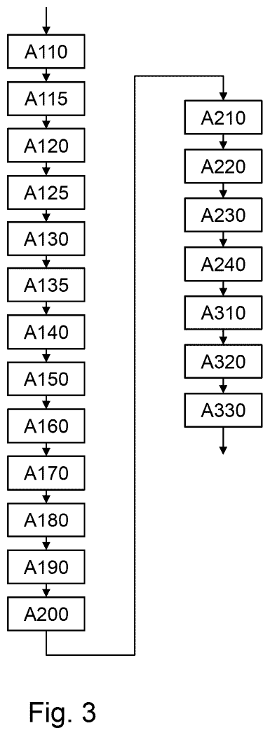

FIG. 3 shows a schematic flowchart, illustrating an exemplifying method according to the embodiments herein. Thus, as an example, the calibration apparatus 110 can perform a method for determining a first transformation TAB between a first coordinate system of a first camera A and a second coordinate system of a second camera B. The method can be a computer-implemented method for determining the first transformation, e.g., a transformation from the first coordinate system of the first camera A to the second coordinate system of the second camera B, or vice versa by inverting the transformation. As mentioned, the first and second cameras A, B are spaced away from each other and located above a ground plane G, xz-plane. As an example, the first and second cameras A, B are standing on the ground plane G.

A first field of view of the first camera A at least partially overlaps with a second field of view of the second camera B. A third camera C has a third field of view partially overlapping with the first and second fields of view. The third camera's C position and the first camera's A position are approximated to be equal, e.g., in the first coordinate system. Notably, the third camera C can be considered to have same position/translation as the first camera A, e.g., in the first coordinate system, but it can have different orientation as compared to the first camera A.

A distant object P is present in the first, second and third fields of view and located at an object distance D from a location AB at at least one of the first camera A, the second camera B, and the third camera C, preferably at the first camera A.

A first marker R and a second marker L are located at the ground plane G and the first and second markers R, L are visible in the second and third fields of view.

A second transformation TBC refers to transformation between the second coordinate system of the second camera B and a third coordinate system of the third camera C. A third transformation TAC refers to transformation between the first coordinate system of the first camera A and the third coordinate system of the third camera C.

As mentioned, the first camera A has a first focal length f′a, i.e., a known focal length.

A first measure A′R indicates a first distance, projected on the ground plane G, between the first marker R and at least one of the first camera A and the third camera C. A second measure A′L indicates a second distance, projected on the ground plane G, between the second marker L and at least one of the first camera A and the third camera C. A third measure A′B′ indicates a third distance, projected on the ground plane G, between the second camera B and at least one of the first camera A and the third camera C. A fourth measure B′R indicates a fourth distance, projected on the ground plane G, between the second camera B and the first marker R. A fifth measure B′L indicates a fifth distance, projected on the ground plane G, between the second camera B and the second marker L. A sixth measure RL indicates a sixth distance, projected on the ground plane G, between the first marker R and the second marker L.

It may in particular be noted that for example the first distance is a projection of the distance between the first camera A and the first marker R on the ground plane G. Likewise:
the second distance is a projection of the distance between the first camera A and the second marker L on the ground plane G,
the fourth distance is a projection of the distance between the second camera B and the first marker R on the ground plane G,
the fifth distance is a projection of the distance between the second camera B and the second marker L on the ground plane G.

These are noteworthy since the markers' R, L and the cameras' centers differ in height above the ground plane G. In this manner, it is thus the projections of the distances between the markers and cameras on the ground plane G that are reflected by the measures mentioned above. Since the markers can be located at the ground, the sixth distance can inherently be located at, or in, the ground plane, or the projection on the ground plane is approximately equal to the unprojected sixth distance.

A seventh measure hAC-B indicates a seventh distance indicating difference in height between the second camera B and at least one of the first and third cameras A, C. A first angle measure vA indicates a feature angle identified in a first image plane representing the first field of view. A second angle measure vB indicates the feature angle identified in a second image plane representing the second field of view. A third angle measure vC indicates the feature angle identified in a third image plane representing the third field of view.

One or more of the following actions can be performed, e.g., in any suitable order. The actions can be performed by one or more physical and/or virtual units.

### Action A110

With reference to FIG. 2a and FIG. 2b, it can be seen that:
A′ denotes the projected optical center of camera A in the ground plane G,
B′ denotes the projected optical center of camera B in the ground plane G,
R denotes the position of the first marker in the ground plane G, and
L denotes the position of the second marker in the ground plane G.

The projected position of the camera lens' optical center on the ground plane G is estimated, e.g., using a plumb bob with a string, a digital distance measurement device, or the like. The position on the ground may be temporarily marked. This is done for the first camera A and the second camera B. These temporary or virtual points A′, B′ on the ground plane G may be referred to as a first point A′ and a second point B′.

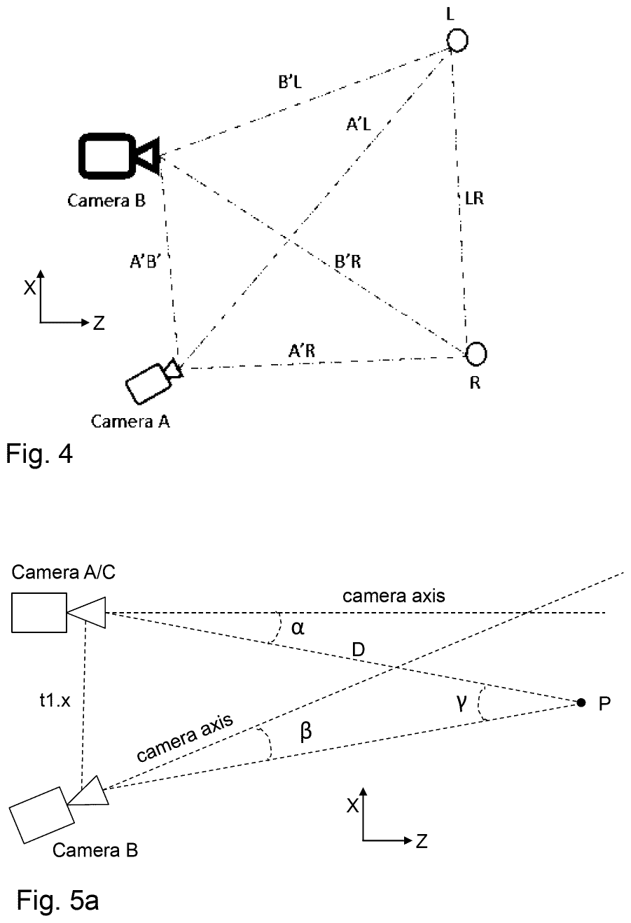

With reference to FIG. 4, it can be seen that:
A′B′ denotes distance from A′ to B′,
A′L denotes distance from A′ to L,
A′R denotes distance from A′ to R,
B′R denotes distance from B′ to R,
B′L denotes distance from B′ to L, and
RL denotes distance from R to L.

Accordingly, the calibration apparatus 110 may obtain, such as receives, fetches or the like, a set of measures, e.g., as user input, from a memory or the like. The memory can be any memory accessible by the calibration apparatus 110. The set of measures includes at least five of:
the first measure A′R,
the second measure A′L,
the third measure A′B′,
the fourth measure B′R,
the fifth measure B′L, or
the sixth measure RL.

In some examples, when the set of measures comprises all but one measure of the first, second, third, fourth, fifth and sixth measures, the calibration apparatus 110 can calculate said one measure based on the set of measures.

As an example, at least five of these six measures can be measured, e.g., using a measuring tape, a laser measuring device, or the like. Preferably, the measures are taken along, e.g., parallelly with, the ground plane G.

### Action A115

The calibration apparatus 110 may obtain, such as receive, fetch or the like, the seventh measure, the first angle measure vA, the second angle measure vB, and the third angle measure vC, e.g., as user input, from a memory or the like. The memory can be any memory accessible by the calibration apparatus 110.

As an example, the calibration apparatus 110 can obtain the seventh measure as an indication of a translation component t0.y, e.g., by means of measurement, for the second transformation TBC.

As an example, an estimation of t0.y may be obtained by measuring the height above ground, e.g., the ground plane G, with a measuring tape for the second camera B and the first or third camera A, C. The difference in height is the estimation of the translation component, t0.y, for the second transformation, or even the first transformation.

### Action A120

The calibration apparatus 110 may obtain, such as receive, fetch or the like, the object distance D, e.g., as user input, from a memory or the like. The memory can be any memory accessible by the calibration apparatus 110.

As mentioned, the object distance D is between the distant object P and a location AB at the first camera A and/or the second camera B and/or the third camera C. The distant object may be visible in the first, second and third cameras A, B, C, i.e., in the fields of view thereof. In this manner, the calibration apparatus 110 may obtain an indication of the object distance D, e.g., a measure thereof. This may mean that the indication may be obtained by means of a measurement. As an example, a laser range finder may be used to measure the distance D from at least one of cameras A, B and C to the distinct object P, e.g., being located far away. A position of the distant object P on the image sensors in camera A, B and C are denoted pa, pb, and pc, respectively. T1.x can be approximated to the third measure A′B′. It may here be noted that the object distance D may be obtained between a point on distant object P and the location AB. The location AB can be at the first camera A, the second camera B, or the third camera between the first, second and third cameras A, B, C or near the first, second or third camera A, B, C, or the like.

As an example, the calibration apparatus 110 can receive, e.g., by input from a user, an indication of the object distance D. Additionally, and/or alternatively, the calibration apparatus 110 can obtain the indication from a memory, accessible by the calibration apparatus 110. In some examples, the indication is received from a measurement device. Such measurement device may be integrated with one of the first, second and third cameras A, B, C or be separated therefrom.

In view of the above, it shall be understood that the object distance D can be used as an approximation and can refer to one or more of the following distances:
a distance between the distant object P and the first camera A, e.g., an optical center of optics of the first camera A,
a distance between the distant object P and the second camera B, e.g., an optical center of optics of the second camera B,
a distance between the distant object P and a location AB in the vicinity of or between the first camera A and/or the second camera B, or
a combination thereof.

### Action A125

The calibration apparatus 110 may obtain, such as receive, fetch, or the like, the first focal length of the first camera A, e.g., as user input, from a memory or the like. The memory can be any memory accessible by the calibration apparatus 110.

### Action A130

The calibration apparatus 110 may calculate a two-dimensional sensor size of the first, second and third camera, respectively, based on the image resolution of the first, second and third camera, respectively.

As an example, the two-dimensional sensor size and/or aspect ratio can be obtained from tables of sensor types, sensor manufacturer's data sheets and the like. In some examples, a standard 35 mm film (full frame) can be assumed. However, in case an actual aspect ratio of processed image indicates that the image has not been captured by a 35 mm film sensor, it is preferred to re-scale the image. A 35 mm film sensor implies a sensor size of 36×24 mm. Hence, as an example, when the actual aspect ratio differs from 3:2 (i.e., 36:24), the sensor size can be rescaled to for example 36 (unchanged) by 20 (rescaled), where one of the height or width is maintained and the other one is rescaled.

### Action A135

The calibration apparatus 110 may calculate an aspect ratio of images captured by the first, second and third camera, respectively, based on the image resolution of the first, second and third camera, respectively.

As an example, an aspect ratio can be calculated, e.g., by prime factorizing the two-dimensional image resolution and subsequently eliminating redundant factors. Thus, an aspect ratio like e.g., 4:3, 14:9, 16:9, 16:10, 1.85:1, 2:1, etc. can be obtained.

In view of action A130 and A135, it is to be noted that image resolution, aspect ratio, and/or sensor size may be used interchangeably in the following, since if one is known the others can be determined, e.g., provided that a size of each pixel is known, e.g., from data sheets, sensor manufacturer's tables, or the like.

### Action A140

The calibration apparatus 110 estimates a third focal length of the third camera C based on
the first measure A′R,
the second measure A′L,
a third position of the first marker R in the third field of view r′3,
a fourth position of the second marker L in the third field of view l′3,
the sixth measure RL, and
an image resolution of the third camera C, resc, e.g., in the x-dimension.

As an example, positions of the first and second markers R, L in the third field of view may be annotated, i.e., l′3 and r′3, respectively. As an example, the third and fourth positions can be obtained from an image captured by the third camera C, such as in the xy-plane of the image. The captured image can be obtained, such as received or the like, by the calibration apparatus 110 in order for the calibration apparatus 110 to gain access to the image and obtain, such as identify, or the like, the third and fourth positions in the image of the third camera C.

The sensor size csc of the third camera C can be estimated, e.g., via the aspect ratio, as explained above, at least in the x-dimension, preferably both x- and y-dimensions.

Triangle conformity yields an initial estimate of the focal length of the third camera C, denoted f′c. Notably, the focal length of the first camera A is considered to be constant and known as mentioned above.

f′c≈f1(A′R, A′L, r′3, l′3, RL, resc, and optionally csc). As an example, f1=(A′R+A′L)*csc.x*abs(r′3.x−l′3.x)/(2*RL*resc.x), where csc.x could be expressed as a function of resc.x.

It shall be noted that the formula f1, and the other formulas presented below, are examples. In other examples, different formulas can be used for calculating the desired entities. Furthermore, “arcus sine” is the same as “arcsin”, “arcus tangent” is the same as “arctan” and “arcus cosine” is the same as “arccos” as applicable.

In some examples, depending on what formula is used, the calibration apparatus 110 can estimate the third focal length of the third camera C based on at least some of
the first measure A′R,
the second measure A′L,
the third position of the first marker R in the third field of view r′3,
the fourth position of the second marker L in the third field of view l′3,
the sixth measure RL, and
the image resolution of the third camera C, resc, e.g., in the x-dimension.

In e.g., at least action A150, A160, and A170 the third transformation TAC is calculated.

### Action A150

The calibration apparatus 110 estimates initial orientation components r3 of the third transformation TAC based on
the distant object's P position in the first camera A, i.e., a position, in the first
camera A, of the distant object P,
an image resolution of the first camera A resa,
the first focal length,
the distant object's P position in the third camera C,
the image resolution of the third camera C,
the third focal length,
the object distance D,
the first angle measure vA, and
the third angle measure vC.

Here, initial orientation components r3 of the third transformation TAC refers to initial values/estimates of the orientation components r3 of the third transformation TAC.

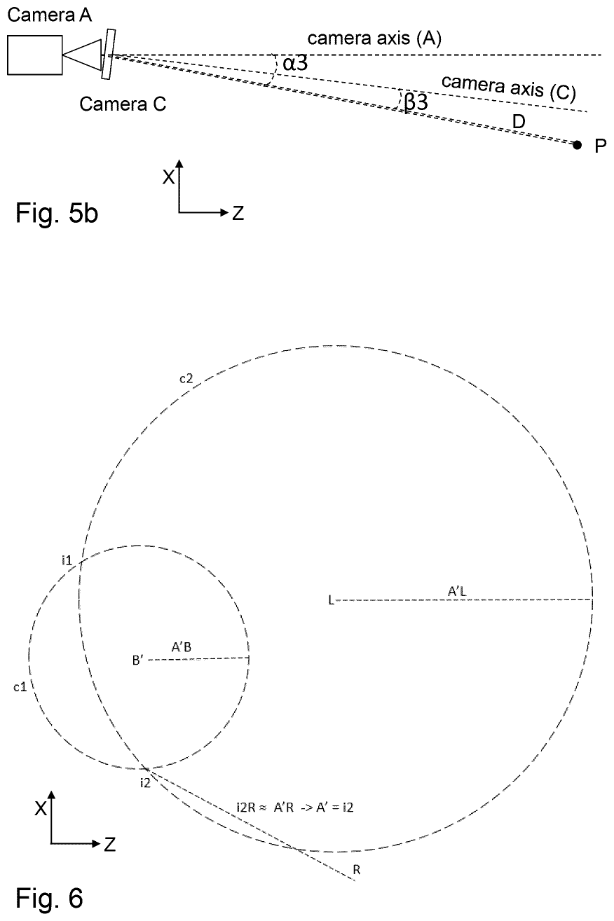

As an example, the calibration apparatus 110 can estimate an orientation component r3.y of the third transformation TAC by determining a third set of angles, as illustrated in FIG. 5b. The third set of angles comprises a seventh angle α3 and an eighth angle β3.

The calibration apparatus 110 can determine the seventh angle α3, in the ground plane G. The seventh angle α3 is indicative of the distant object's P deviation from the first camera's A straight viewing direction. The determining/determination A260 is based on:
the distant object's position in the first camera A, pa,
sensor size along x-axis of the first camera A, csa,
the focal length of the first camera A, f′a, and
the object distance D, such as a distance between the distant object P and the first camera A or the like.

$$α3 \approx f 2 ( pa , csa , {f}^{′} a , D )$$

See example of f2 above. Hence, as an example α3˜arc tan(((pa.x−resa.x*0.5)*csa.x/resa.x)/f′a).

As an example, the object distance D can be used to tune the value of f′a.

For simplicity, sensor size is referenced above, but as already mentioned the sensor size can be determined from the resolution.

The calibration apparatus 110 can determine an eighth angle β3, in the ground plane G, xz, indicative of the distant object's P deviation from the third camera's C straight viewing direction based on:
the distant object's position in the third camera C,
sensor size along x-axis of the third camera C,
the focal length of the third camera C, and
the object distance D, such as a distance between the distant object P and the third camera C or the like.
β3≈f2 (pc, csc, f′c, D). f2 may be the same function as above, e.g., β3≈arc tan(((pc.x−resc.x*0.5)*csc.x/resc.x)/f′c).

As an example, the object distance D can be used to tune the value of f′c.

In view of the actions relating to the seventh and eighth angle, looking down the negative y-axis, the two angles α3 and β3 in the ground plane G can be calculated using ordinary trigonometry.

The calibration apparatus 110 can estimate the orientation component r3.y of the third transformation TAC based on the seventh angle and the eighth angle.

In some embodiments, the calibration apparatus 110 estimates the orientation component r3.y by calculating the orientation component r3.y as the seventh angle reduced by the eighth angle.

Expressed using the notation herein: r3.y≈α3−β3.

An orientation component r3.x of the third transformation can be estimated by performing corresponding calculations as above, while considering angles in the yz-plane, aka a second plane yz that is perpendicular to the ground plane G and that is parallel with the first camera's A straight viewing direction.

As an example, an orientation component r3.z of the third transformation can be estimated based on
the first angle measure vA, and
the third angle measure vC.

The first angle measure vA is given in the first coordinate system of the first camera A and the third angle measure vC is given in the third coordinate system of the third camera C.

Generally, an angle measure vX, such as any one or more of the first, second and third angle measures vA, vB and vC can be obtained by measuring an identifiable angle in the field of view of the camera under observation, such as the first, second and/or third camera A, B, C.

Such identifiable angle can be defined by two feature points, where each feature point can be identified manually and/or by means of image recognition.

The feature points may preferably be centered but spaced away from each other. The feature points are typically located distant to the first, second and third cameras A, B, C. The feature points may be points of, such as at, on or the like, the distant object P. However, the feature points may alternatively or also, be taken from one or more other points identified in one or more of the first, second and third fields of view.

As an example, the calibration apparatus 110 can obtain at least a first indication and at least a second indication. The first indication relates to a first distance between the first camera A and a first feature point, and wherein the second indication relates to a second distance between the first camera A and a second feature point. The first and second feature points are included in one or more of the first, second and third fields of view. As an example, a laser range finder can be used to measure the first distance from the first camera A to any number of feature points visible in one or more of the first, second and third cameras, such as the first and second feature points.

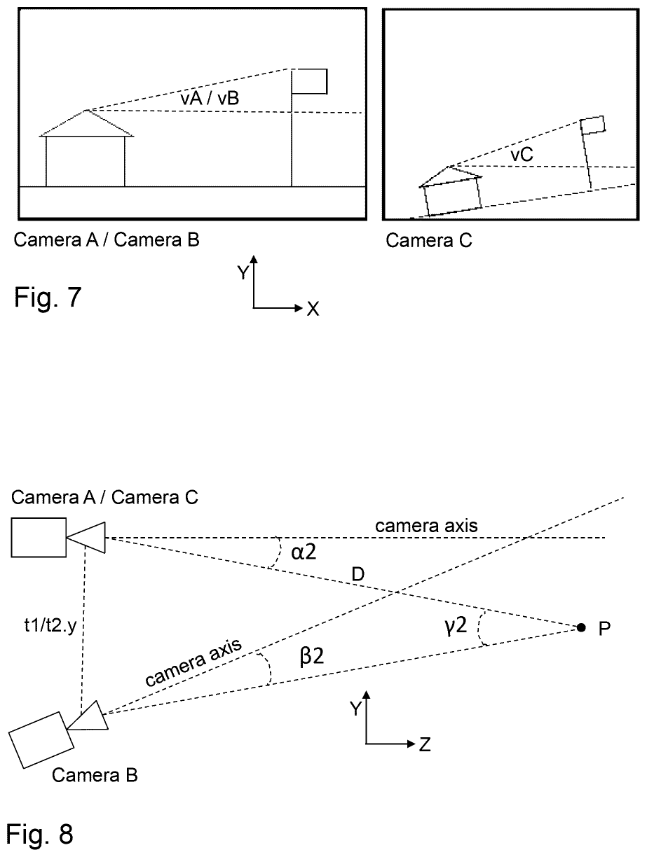

As an example, r3.z is estimated as the difference between the two angle measures vA, vC, i.e., r3.z≈vA−vC. Reference is made to FIG. 7.

The feature points, denoted p1, p2, can generally be visible in the fields of view of both cameras, such as the first camera A and the third camera C. Their two-dimensional image positions are denoted as p1a, p1c, p2a and p2c.

This yields that:

vA=arcus tangent ((p1a.y−p2a.y)/(p1a.x−p2a.x)), and

vC=arcus tangent ((p1c.y−p2c.y)/(p1c.x−p2c.x)).

Therefore, depending on the formulas used, the calibration apparatus 110 can estimate the initial orientation components r3 of the third transformation TAC based on at least some of
the distant object's P position in the first camera A, i.e., a position, in the first camera A, of the distant object P,
the image resolution of the first camera A resa,
the first focal length,
the distant object's P position in the third camera C,
the image resolution of the third camera C,
the third focal length,
the object distance D,
the first angle measure vA, and
the third angle measure vC.

### Action A160

The calibration apparatus 110 estimates initial translation components t3 of the third transformation TAC to be zero. This is consequence of that the first and second camera A, C are considered to be located at the same position, e.g., in the first coordinate system. As mentioned, the first and second cameras A, C can have different orientations, e.g., different viewing directions, but the first and second fields of view are nevertheless at least partially overlapping.

### Action A170

Since the initial estimates of the translation and orientation components t3, r3 of the third transformation TAC now have been set, improvements thereof can be achieved by iteration under constraints.

Thus, the calibration apparatus 110 iteratively determines updated orientation components of the third transformation TAC and an updated third focal length under a third constraint that a third reprojection error for at least one reprojection point in the first and third fields of view satisfies a third condition for allowed reprojection error.

In some examples, the calibration apparatus 110 can perform the iteratively determining of the updated orientation components of the third transformation TAC and the updated third focal length by solving a third mathematical equation system including orientation components and translation components, e.g. as initially estimated but at least one thereof being adjusted in each iteration, of the third transformation and the third focal length while satisfying the third constraint, thereby obtaining the updated orientation components for the third transformation and the updated third focal length.

Expressed differently, as an example, with the initial estimations of t3, r3 and f′c, the third transformation between camera A and camera C is created. The quality of any estimation of t3, r3 and f′c can be evaluated by comparing estimated positions of, e.g., a reprojection point or the like, and actual, or detected, positions of the reprojection point(s). The quality can be measured as the sum of all reprojection errors obtain with the third transformation. An optimization problem for r3 and f′c, is formulated, where a cost function is a weighted sum of all reprojection error(s). As an example, a known gradient descend procedure may be used to find a solution to the optimization problem. Gradient descent procedures are well-known in related mathematical literature and refers to a first-order iterative optimization algorithm for finding a local minimum of a differentiable function.

As an example, the iteratively determining can improve the estimates of the orientation components r3 and the third focal length, but typically the estimates of the translation components t3 remains to be zero.

In e.g., at least action A180, A190, A200, and A210 below the second transformation TBC is calculated.

### Action A180

The calibration apparatus 110 estimates a second focal length of the second camera B based on
the fourth measure B′R,
the fifth measure B′L,
a first position of the first marker R in the second field of view r′,
a second position of the second marker L in the second field of view l′,
the sixth measure RL, and
an image resolution of the second camera B, e.g., in the x-dimension.

As an example, positions of the first and second markers in the second field of view of the second camera B may be annotated, i.e., l′ and r′ respectively. As an example, the first and second positions can be obtained from an image captured by the second camera B, such as in the xy-plane of the image. The captured image can be obtained, such as received or the like, by the calibration apparatus 110 in order for the calibration apparatus 110 to gain access to the image and obtain, such as identify, or the like, the first and second positions in the image of the second camera B.

The sensor size csb of the third camera C can be estimated, e.g., via the aspect ratio, as explained above, at least in the x-dimension.

Triangle conformity yields an initial estimate of f′ for camera B, denoted f′b. Notably, the focal length of the first camera A is considered to be constant and known as mentioned above.

f′b=f1 (B′R, B′L, r′, l′, csb, RL, resb). As an example, f1=(B′R+B′L)*csb.x*abs (r′.x−l′.x)/(2*RL*resb.x), where csb.x could be expressed as a function of resb.x.

It shall be noted that the formula f1, and the other formulas presented below, are examples. In other examples, different formulas can be used for calculating the desired entities. Furthermore, “arcus sine” is the same as “arcsin”, “arcus tangent” is the same as “arctan” and “arcus cosine” is the same as “arccos” as applicable.

In some examples, depending on the formula used, the calibration apparatus 110 can estimate the second focal length of the second camera B based on at least some of
the fourth measure B′R,
the fifth measure B′L,
the first position of the first marker R in the second field of view r′,
the second position of the second marker L in the second field of view l′,
the sixth measure RL, and
   an image resolution of the second camera B, e.g., in the x-dimension.

### Action A190

The calibration apparatus 110 estimates initial orientation components r2 of the second transformation TBC based on
the distant object's position in the second camera B,
an image resolution of the second camera B resb,
the second focal length, and
the distant object's position in the third camera C,
an image resolution of the third camera C,
the third focal length,
the object distance D,
the third measure A′B′,
the seventh measure hAC-B,
the second angle measure vB, and
the third angle measure vC.

As an example, the calibration apparatus 110 can estimate an orientation component r2.y of the second transformation TBC by determining a second set of angles, as illustrated in FIG. 5a. The second set of angles comprises:
a first angle α, in a first plane G′, xz that is parallel with the ground plane G, indicative of the distant object's P deviation from the third camera's C straight viewing direction, aka camera axis,
a second angle β, in the first plane G′, indicative of the distant object's deviation from the second camera's B straight viewing direction, and
a third angle γ, in the first plane G′, having a vertex at the distant object's position and two rays to the first and second cameras A, B, respectively.

The calibration apparatus 110 can determine the first angle α based on:
the distant object's P position in the third camera C, pc,
sensor size along x-axis of the third camera C, csc,
a two-dimensional image resolution of the third camera C, resc, and
the object distance D, such as a distance between the distant object P and the third camera C or the like.

As observed along the y-axis, e.g., down the negative y-axis, the three first, second and third angles α, β, γ in the xz-plane may be calculated using ordinary trigonometry, see also FIG. 5a.

$$α \approx f 2 ( pc , csc , {f}^{′} c , D ) .$$

As an example, a≈arc tan(((pc.x−resc.x*0.5)*csc.x/resc.x)/f′c), where csc can be expressed as a function of resc (as mentioned earlier).

As an example, the object distance D can be used to tune the value of f′c.

The calibration apparatus 110 can determine the second angle B based on:
the distant object's position in the second camera B, pb,
sensor size, e.g., along x-axis, of the second camera B, csb,
a two-dimensional image resolution of the second camera B, resb,
the distance D between the second or third (or point in vicinity of camera B and C) camera B, C and the distant object P.

B≈f2 (pb, csb, f′b, D), f2 can be the same function as above. As an example, β≈arctan(((pb.x−resb.x*0.5)*csb.x/resb.x)/f′b). Again, csb can be expressed as a function of resb.

As an example, the object distance D can be used to tune the value of f′b.

The calibration apparatus 110 can determine the third angle Y based on:
the third measure A′B′, and
the object distance D.

The third measure is used as an initial estimation of t2.x, while recalling that the first and third cameras A, C are considered to be located at the same position, or approximately the same position.

γ≈f3 (t2.x, D). As an example, f3=t2.x/D.

Now, the calibration apparatus 110 can estimate an orientation component r2.y of the second transformation in the first plane G′ based on the first angle, the second angle and the third angle. In some embodiments, the calibration apparatus 110 estimates the orientation component r2.y by calculating the orientation component r2.y as the first angle reduced by the second angle and adding the third angle. Expressed using the notation herein: r0.y≈α−β+γ.

Furthermore, with reference to FIG. 8, an orientation component r2.x of the second transformation TBC can be determined in a manner corresponding to how the orientation component r2.y above can be determined.

In more detail and as an example, the calibration apparatus 110 can estimate the orientation component r2.x of the second transformation TBC by determining a third set of angles, as illustrated in FIG. 8. The third set of angles comprises:

a fourth angle α2, in a second plane yz that is perpendicular to the ground plane G and that is parallel with the third camera's C straight viewing direction, a fifth angle β2, in the second plane yz, indicative of the distant object's P deviation from the second camera's B straight viewing direction, and a sixth angle γ2, in the second plane yz having a vertex at the distant object's position and two rays to the second and third cameras B, C, respectively.

The fourth angle α2 is indicative of the distant object's P deviation from the third camera's C straight viewing direction.

The calibration apparatus 110 can determine the fourth angle α2 based on:
the distant object's position in the third camera C, pc,
sensor size along y-axis of the third camera C, csc,
the third focal length of the third camera C, f′c, and
the object distance D, such as a distance between the distant object P and the first camera A or the like.

$$α2 \approx f 2 ( pa , csa , {f}^{′} a , D )$$

See example of f2 above. Hence, as an example α2≈arc tan(((pc.y−resc.y*0.5)*csc.y/resc.y)/f′a).

As an example, the object distance D can be used to tune the value of f′a.

The calibration apparatus 110 can determine the fifth angle β2 based on:
the distant object's position in the second camera B,
sensor size along y-axis of the second camera B,
the focal length of the second camera B, and
the object distance D, such as a distance between the distant object P and the second camera B or the like.

β2≈f2 (pb, csb, f′b, D). f2 may be the same function as above, e.g., β2≈arc tan (((pb.y−resb.y*0.5)*csb.y/resb.y)/f′b).

As an example, the object distance D can be used to tune the value of f′b.

The calibration apparatus 110 can determine the sixth angle γ2 based on:
the seventh measure hAC-B, and
the object distance D.
γ2≈f3 (t2.y, D), where f3 can be the same function as above. As an example, γ2≈t2.y/D.

The seventh measure can be used as an initial estimation of t2.y, e.g., while recalling that the first and third cameras A, C are considered to be located at the same position, or approximately the same position.

In view of the actions relating to the fourth, fifth and sixth angle, looking down the negative x-axis, the three angles α2, β2 and γ2 in the yz-plane have been calculated using ordinary trigonometry.

The calibration apparatus 110 estimates an orientation component r2.x of the second transformation TBC based on the fourth angle, the fifth angle and the sixth angle. In some embodiments, the calibration apparatus 110 estimates the orientation component r2.x by calculating the orientation component r2.x as the fourth angle reduced by the fifth angle and adding the sixth angle. Expressed using the notation herein: r2.x≈α2−β2+γ2.

Furthermore, r2.z can be estimated based on the two angle measures vB, vC, e.g., the second angle measure vB and the third angle measure vC, in the same or similar manner as explained above.

Accordingly, as an example, r2.z is estimated as the difference between the two angle measures vB, vC, i.e., r2.z≈vB−vC. Reference is made to FIG. 7.

The feature points, denoted p1, p2, can generally be visible in the fields of view of both cameras, such as the second camera B and the third camera C. Their two-dimensional image positions are denoted as p1b, p1c, p2b and p2c.

This yields that:

$$vB = arcus tangent ( ( p 1 b . y - p 2 b . y ) / ( p 1 b . x - p 2 b . x ) ) ,$$

$$and$$

$$vC = arcus tangent ( ( p 1 c . y - p 2 c . y ) / ( p 1 c . x - p 2 c . x ) ) .$$

Hence, again in some examples, depending on the formulas used, the calibration apparatus 110 can estimate the initial orientation components r2 of the second transformation TBC based on at least some of
the distant object's position in the second camera B,
the image resolution of the second camera B resb,
the second focal length, and
the distant object's position in the third camera C,
the image resolution of the third camera C,
the third focal length,
the object distance D,
the third measure A′B′,
the seventh measure hAC-B,
the second angle measure vB, and
the third angle measure vC.

### Action A200

The calibration apparatus 110 estimates initial second translation components t2 of the second transformation TBC based on
the third measure A′B′ defining a radius of an imaginary circle centered at camera B,
the second measure A′L defining a radius of an imaginary circle centered at the second marker L,
the fifth measure B′L, and
the seventh measure hAC-B.

While it is assumed that the center points of the two imaginary circles and the radii make the two imaginary circles intersect, the translation difference between the center points can be determined by solving a second-degree equation. If choosing the second or third coordinate system as the reference, then the initial second translation components t2.x, t2.z. can be approximated with the components of the translation difference. The second-degree equation can be solved in numerous known manners.

The seventh measure hAC-B can be used as initial estimate of a translation component t2.y of the second transformation.

Now referring to FIG. 6, as an example of how to obtain the initial second translation components t2.x and t2.z by finding the intersections between the two imaginary circles. Again, recall that the first and third cameras A, C can be considered to be located at the same position.

The calibration apparatus 110 can define a first imaginary circle c1, being centered at a point B′ defined by a projection of an optical center of the second camera B at the ground plane G and having a radius defined by the third measure A′B′, and a second imaginary circle c2, being centered at the second marker L and having a radius defined by the second measure A′L. In more detail, the first and second circles c1, c2 are parallel with the ground plane G.

The calibration apparatus 110 can then determine a first intersection i1 and a second intersection i2 between the first and second circles c1, c2, e.g., by solving a second-degree equation.

Next, the calibration apparatus 110 can select one of the first and second intersections i1, i2 as a position of the third camera C on the ground plane based on a comparison between 1) the first measure A′R and a first distance i1R between the first intersection i1 and the first marker R and between 2) the first measure A′R and a second distance i2R between the second intersection i2 and the first marker R.

Further, the calibration apparatus 110 can estimate the second translation components t2.x and t2.z of the second transformation based on at least the selected intersection and the first marker R.

It may be concluded that the position A′ of the third camera C on the plane ground G must have the same position as i1 or i2. There are then two possible solutions. The correct solution (i) is chosen by calculating the distance to R from both the first and second intersections i1, i2 and comparing those distances with the measured distance A′L. This yields an estimation of t2.x and t2.z.

In some examples, depending on the formulas used, the calibration apparatus 110 can estimate the initial second translation components t2 of the second transformation TBC based on at least some of
the third measure A′B′ defining a radius of an imaginary circle centered at camera B,
the second measure A′L defining a radius of an imaginary circle centered at the second marker L,
the fifth measure B′L, and
the seventh measure hAC-B.

### Action A210

Since the initial estimates of the translation and orientation components t2, r2 of the second transformation TBC now have been set, improvements thereof can be achieved by iteration under constraints.

The calibration apparatus 110 iteratively determines updated orientation and translation components for the second transformation TBC and an updated second focal length under a second constraint that a second reprojection error for at least one reprojection point in the second and third fields of view satisfies a second condition for allowed reprojection error.

In some examples, the calibration apparatus 110 can perform the iteratively determining of the updated orientation and translation components for the second transformation and the updated second focal length by solving a second mathematical equation system including orientation and translation components, e.g. as initially estimated but at least one thereof being adjusted in each iteration, of the second transformation and the second focal length while satisfying the second constraint, thereby obtaining the updated orientation and translation components for the second transformation and the updated second focal length.

Expressed differently, as an example, with the initial estimations of t2, r2 and f′b, the second transformation between the second camera B and the third camera C is created. The quality of any estimation of t2, r2 and f′b can be evaluated by comparing estimated positions of, e.g., a reprojection point or the like, and actual, or detected, positions of the reprojection point(s). The quality can be measured as the sum of all reprojection errors obtain with the third transformation. An optimization problem for t2, r2 and f′b, is formulated, where a cost function is a weighted sum of all reprojection error(s). As an example, a known gradient descend procedure may be used to find a solution to the optimization problem. Gradient descent procedures are well-known in related mathematical literature and refers to a first-order iterative optimization algorithm for finding a local minimum of a differentiable function.

In more detail, a number of reprojection points, or calibration points, can vary, but there can preferably be two, three or more reprojection points.

If the number of reprojection points is at least three, then the iteratively determining can improve at least the estimates of the orientation components r2 and the second focal length, but if the number of reprojection points is less than three, then the iteratively determining can only improve the estimates of the orientation components r2.x and r2.y and the second focal length. However, regardless the number of reprojection points, given that the first and second markers R, L in the second and third fields of view, the iteratively determining can improve at least the estimates of the translation components t2, e.g., in three dimensions.

### Action A220

The calibration apparatus 110 estimates initial first orientation components r1 for the first transformation based on the updated second orientation components r2 and the updated third orientation components r3.

### Action A230

The calibration apparatus 110 estimates initial translation components t1 for the first transformation based on the updated second translation components t2. Again, it can be recalled that initial translation components t3 were estimated to be zero.

### Action A240

The calibration apparatus 110 iteratively determines at least updated orientation components for the first transformation and a further updated second focal length under a first constraint that a first reprojection error for at least one reprojection point in the first and second fields of view satisfies a first condition for allowed reprojection error.

In some examples, the calibration apparatus 110 can perform the iteratively determining of at least the updated orientation components for the first transformation and the further updated second focal length by solving a first mathematical equation system including orientation and translation components of the first transformation and the second focal length while satisfying the first constraint, thereby obtaining said at least updated orientation components for the first transformation and the further updated second focal length.

Expressed differently, as an example, with the initial estimations of t1, r1 and f′b, the first transformation between the first camera A and the second camera B is created. The quality of any estimation of t1, r1 and f′b can be evaluated by comparing estimated positions of, e.g., a reprojection point or the like, and actual, or detected, positions of the reprojection point(s). The quality can be measured as the sum of all reprojection errors obtain with the first transformation. An optimization problem for r1 and f′b, is formulated, where a cost function is a weighted sum of all reprojection error(s). As an example, a known gradient descend procedure may be used to find a solution to the optimization problem. Gradient descent procedures are well-known in related mathematical literature and refers to a first-order iterative optimization algorithm for finding a local minimum of a differentiable function.

Hence, there are final estimations of t1, r1 and f′b that that be used for transforming any coordinate in the first coordinate system to a transformed coordinate in the second coordinate system, such as a tracking trace in the first coordinate system to a transformed tracking trace in the second coordinate system. The transformed tracking trace can then be rendered in a video stream from the second camera B.

In more detail, a number of reprojection points, or calibration points, can vary, but there can preferably be two, three or more reprojection points.

If the number of reprojection points is at least three, then the iteratively determining can improve at least the estimates of the orientation components r1 and the second focal length, but if the number of reprojection points is less than three, then the iteratively determining can only improve the estimates of the orientation components r1.x and r1.y and the second focal length.

It can here be noted that actions A310, A320 and A330 are described as being performed by the calibration apparatus 110. However, these actions can be performed by one or more further computer devices (not shown).

### Action A310

The calibration apparatus 110 can receive, from the first camera A, a tracking stream relating to a tracked object 120. As an example, the tracking stream includes information for generating a tracking trace relating to the tracked object 120.

The tracking stream can include one or more of image frames captured by the first camera A, tracking data, blob information, paths, tracks, radar data, or the like.

The tracked object 120 can be a sports projectile, such as a golf ball, table tennis ball, a football, a soccer ball, a tennis ball, badminton ball, or the like.

The tracked object 120 can move in a three-dimensional environment in the fields of view of the first camera A and the second camera B.

A path of the tracked object 120 is captured by the first camera A. The tracking stream can include one or more of image frames captured by the first camera A, tracking data, blob information, paths, tracks, radar data or the like.

### Action A320

The calibration apparatus 110 can receive a video stream from the second camera B. Accordingly, the video stream is captured by the second camera B.

### Action A330

The calibration apparatus 110 may render the tracking trace relating to the tracked object 120 in the video stream based on the tracking stream, while using the first transformation. Any procedure for generating the tracking trace based on the tracking stream can used, e.g., before or in combination with action A330.

In this manner, the final estimations can be used to transform a tracking trace in the coordinate system of the first camera A to a transformed tracking trace in the coordinate system of the second camera B, i.e., the same coordinate system as the video stream. Next, the tracking trace can be rendered in the video stream. As a result, the experience of the video stream is enhanced for viewers of the video stream.

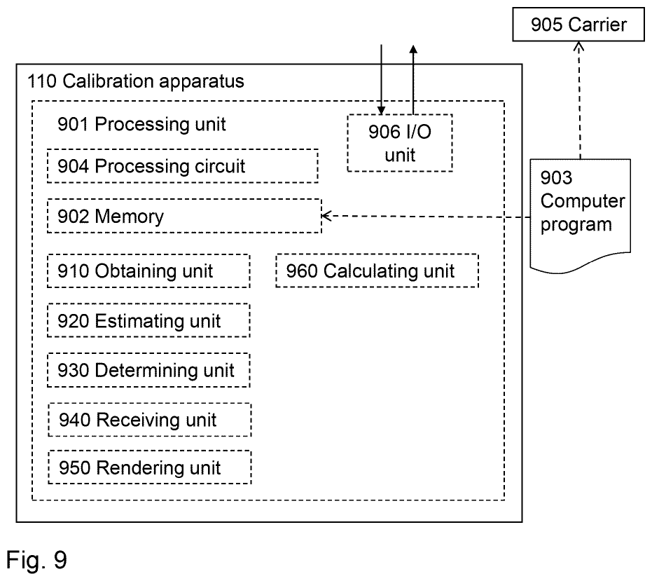

With reference to FIG. 9, a schematic block diagram of embodiments of the calibration apparatus 110 of FIG. 1 is shown.

The calibration apparatus 110 can include a processing unit 901 for performing the methods described herein. The processing unit can be embodied in the form of one or more hardware units and/or one or more software units. The term “unit” may thus refer to a circuit, a software block or the like according to various embodiments as described below.

The calibration apparatus 110 may further include a memory 902. The memory can include, such as contain or store, instructions, e.g., in the form of a computer program 903, which can include computer readable code units.

According to some embodiments herein, the calibration apparatus 110 and/or the processing unit 901 includes a processing circuit 904 as an exemplifying hardware unit, which can include one or more processors. Accordingly, the processing unit 901 may be embodied in the form of, or ‘realized by’, the processing circuit 904. The instructions may be executable by the processing circuit 904, whereby the calibration apparatus 110 is operative to perform the methods of FIG. 3. As another example, the instructions, when executed by the calibration apparatus 110 and/or the processing circuit 904, may cause the calibration apparatus 110 to perform the method according to FIG. 3.

In view of the above, in one example, there is provided a calibration apparatus 110 configured for determining a first transformation (TAB) between a first coordinate system of a first camera (A) and a second coordinate system of a second camera (B). As mentioned, the first and second cameras (A, B) are spaced away from each other and located above a ground plane (G, xz-plane), wherein a first field of view of the first camera (A) at least partially overlaps with a second field of view of the second camera (B), wherein a third camera (C) has a third field of view partially overlapping with the first and second fields of view, wherein the third camera's (C) position and the first camera's (A) position are approximated to be equal, wherein a distant object (P) is present in the first, second and third fields of view and located at an object distance (D) from a location (AB) at at least one of the first camera (A), the second camera (B), and the third camera (C), preferably at the first camera (A), wherein a first marker (R) and a second marker (L) are located at the ground plane (G) and the first and second markers (R, L) are visible in the second and third fields of view, wherein a second transformation (TBC) refers to transformation between the second coordinate system of the second camera (B) and a third coordinate system of the third camera (C), wherein a third transformation (TAC) refers to transformation between the first coordinate system of the first camera (A) and the third coordinate system of the third camera (C), wherein the first camera (A) has a first focal length, wherein a first measure (A′R) indicates a first distance, projected on the ground plane (G), between the first marker (R) and at least one of the first camera (A) and the third camera (C), wherein a second measure (A′L) indicates a second distance, projected on the ground plane (G), between the second marker (L) and at least one of the first camera (A) and the third camera (C), wherein a third measure (A′B′) indicates a third distance, projected on the ground plane (G), between the second camera (B) and at least one of the first camera (A) and the third camera (C), wherein a fourth measure (B′R) indicates a fourth distance, projected on the ground plane (G), between the second camera (B) and the first marker (R), wherein a fifth measure (B′L) indicates a fifth distance, projected on the ground plane (G), between the second camera (B) and the second marker (L), wherein a sixth measure (RL) indicates a sixth distance, projected on the ground plane (G), between the first marker (R) and the second marker (L), wherein a seventh measure (hAC-B) indicates a seventh distance indicating difference in height between the second camera (B) and at least one of the first and third cameras (A, C), wherein a first angle measure (vA) indicates a feature angle identified in a first image plane representing the first field of view, wherein a second angle measure (vB) indicates the feature angle identified in a second image plane representing the second field of view, wherein a third angle measure (vC) indicates the feature angle identified in a third image plane representing the third field of view. Again, the memory 902 contains the instructions executable by said processing circuit 904 whereby the calibration apparatus 110 is operative for:
estimating A140 a third focal length of the third camera C based on
   the first measure A′R,
   the second measure A′L,
   a third position of the first marker R in the third field of view,
   a fourth position of the second marker L in the third field of view,
   the sixth measure RL, and
   an image resolution of the third camera C,
estimating A150 initial orientation components r3 of the third transformation TAC based on
   the distant object's P position in the first camera A,
   an image resolution of the first camera A,
   the first focal length,
   the distant object's P position in the third camera C,
   the image resolution of the third camera C,
   the third focal length,
   the object distance D,
   the first angle measure vA, and
   the third angle measure vC,
estimating A160 initial translation components t3 of the third transformation TAC to be zero,
iteratively determining A170 updated orientation components of the third transformation TAC and an updated third focal length under a third constraint that a third reprojection error for at least one reprojection point in the first and third fields of view satisfies a third condition for allowed reprojection error,
estimating A180 a second focal length of the second camera B based on
   the fourth measure B′R,
   the fifth measure B′L,
   a first position of the first marker R in the second field of view,
   a second position of the second marker L in the second field of view,
   the sixth measure RL, and
   an image resolution of the second camera B,
estimating A190 initial orientation components r2 of the second transformation TBC based on
   the distant object's position in the second camera B,
   an image resolution of the second camera B,
   the second focal length, and
   the distant object's position in the third camera C,
   an image resolution of the third camera C,
   the third focal length,
   the object distance D,
   the third measure A′B′,
   the seventh measure hAC-B,
   the second angle measure vB, and
   the third angle measure vC,
estimating A200 initial second translation components t2 of the second transformation TBC based on
   the third measure A′B′ defining a radius of an imaginary circle centered at camera B,
   the second measure A′L defining a radius of an imaginary circle centered at the second marker L,
   the fifth measure B′L, and
   the seventh measure hAC-B,
iteratively determining A210 updated orientation and translation components for the second transformation and an updated second focal length under a second constraint that a second reprojection error for at least one reprojection point in the second and third fields of view satisfies a second condition for allowed reprojection error,
estimating A220 initial first orientation components for the first transformation based on the updated second orientation components and the updated third orientation components,
estimating A230 initial translation components for the first transformation based on the updated second translation components,
iteratively determining A240 at least updated orientation components for the first transformation and a further updated second focal length under a first constraint that a first reprojection error for at least one reprojection point in the first and second fields of view satisfies a first condition for allowed reprojection error.

FIG. 9 further illustrates a carrier 905, or program carrier, which provides, such as comprises, mediates, supplies and the like, the computer program 903 as described directly above. The carrier 905 may be one of an electronic signal, an optical signal, a radio signal and a computer readable medium.

In some embodiments, the calibration apparatus 110 and/or the processing unit 901 may comprise one or more of an obtaining unit 910, an estimating unit 920, a determining unit 930, a receiving unit 940, a rendering unit 950, a calculating unit 960, as exemplifying hardware units. The term “unit” may refer to a circuit when the term “unit” refers to a hardware unit. In other examples, one or more of the aforementioned exemplifying hardware units may be implemented as one or more software units.

Moreover, the calibration apparatus 110 and/or the processing unit XX01 may comprise an Input/Output unit 906, which may be exemplified by the receiving unit and/or the sending unit when applicable.

Accordingly, the calibration apparatus 110 is configured determining a first transformation TAB between a first coordinate system of a first camera A and a second coordinate system of a second camera B. The first and second cameras A, B are spaced away from each other and located above a ground plane G, xz-plane. A first field of view of the first camera A at least partially overlaps with a second field of view of the second camera B. A third camera C has a third field of view partially overlapping with the first and second fields of view. The third camera's C position and the first camera's A position are approximated to be equal, e.g., in the first coordinate system, e.g., the third camera C is considered to have same position/translation as the first camera A, but it can have different orientation as compared to the first camera A. A distant object P is present in the first, second and third fields of view and located at an object distance D from a location AB at at least one of the first camera A, the second camera B, and the third camera C, preferably at the first camera A. A first marker R and a second marker L are located at the ground plane G and the first and second markers R, L are visible in the second and third fields of view. A second transformation TBC refers to transformation between the second coordinate system of the second camera B and a third coordinate system of the third camera C. A third transformation TAC refers to transformation between the first coordinate system of the first camera A and the third coordinate system of the third camera C. The first camera A has a first focal length. A first measure A′R indicates a first distance, projected on the ground plane G, between the first marker R and at least one of the first camera A and the third camera C. A second measure A′L indicates a second distance, projected on the ground plane G, between the second marker L and at least one of the first camera A and the third camera C. A third measure A′B′ indicates a third distance, projected on the ground plane G, between the second camera B and at least one of the first camera A and the third camera C. A fourth measure B′R indicates a fourth distance, projected on the ground plane G, between the second camera B and the first marker R. A fifth measure B′L indicates a fifth distance, projected on the ground plane G, between the second camera B and the second marker L. A sixth measure RL indicates a sixth distance, projected on the ground plane G, between the first marker R and the second marker L. A seventh measure hAC-B indicates a seventh distance indicating difference in height between the second camera B and at least one of the first and third cameras A, C. A first angle measure vA indicates a feature angle identified in a first image plane representing the first field of view. A second angle measure vB indicates the feature angle identified in a second image plane representing the second field of view. A third angle measure vC indicates the feature angle identified in a third image plane representing the third field of view.

Therefore, according to the various embodiments described above, the calibration apparatus 110 and/or the processing unit 901 and/or the estimating unit 920 is configured for estimating a third focal length of the third camera C based on
the first measure A′R,
the second measure A′L,
a third position of the first marker R in the third field of view,
a fourth position of the second marker L in the third field of view,
the sixth measure RL, and
an image resolution of the third camera C.

The calibration apparatus 110 and/or the processing unit 901 and/or the estimating unit 920 is configured for estimating initial orientation components r3 of the third transformation TAC based on
the distant object's P position in the first camera A, i.e., a position, in the first camera A, of the distant object P,
an image resolution of the first camera A,
the first focal length,
the distant object's P position in the third camera C,
the image resolution of the third camera C,
the third focal length,
the object distance D,
the first angle measure vA, and
the third angle measure vC.

The calibration apparatus 110 and/or the processing unit 901 and/or the estimating unit 920 is configured for estimating initial translation components t3 of the third transformation TAC to be zero.

The calibration apparatus 110 and/or the processing unit 901 and/or the determining unit 930 is configured for iteratively determining updated orientation components of the third transformation TAC and an updated third focal length under a third constraint that a third reprojection error for at least one reprojection point in the first and third fields of view satisfies a third condition for allowed reprojection error.

The calibration apparatus 110 and/or the processing unit 901 and/or the estimating unit 920 is configured for estimating a second focal length of the second camera B based on
the fourth measure B′R,
the fifth measure B′L,
a first position of the first marker R in the second field of view,
a second position of the second marker L in the second field of view,
the sixth measure RL, and
an image resolution of the second camera B.

The calibration apparatus 110 and/or the processing unit 901 and/or the estimating unit 920 is configured for estimating initial orientation components r2 of the second transformation TBC based on
the distant object's position in the second camera B,
an image resolution of the second camera B,
the second focal length,
the distant object's position in the third camera C,
an image resolution of the third camera C,
the third focal length,
the object distance D,
the third measure A′B′,
the seventh measure hAC-B,
the second angle measure vB, and
the third angle measure vC.

The calibration apparatus 110 and/or the processing unit 901 and/or the estimating unit 920 is configured for estimating initial second translation components t2 of the second transformation TBC based on
the third measure A′B′ defining a radius of an imaginary circle centered at camera B,
the second measure A′L defining a radius of an imaginary circle centered at the second marker L,
the fifth measure B′L, and
the seventh measure hAC-B.

The calibration apparatus 110 and/or the processing unit 901 and/or the determining unit 930 is configured for iteratively determining updated orientation and translation components for the second transformation and an updated second focal length under a second constraint that a second reprojection error for at least one reprojection point in the second and third fields of view satisfies a second condition for allowed reprojection error.

The calibration apparatus 110 and/or the processing unit 901 and/or the estimating unit 920 is configured for estimating initial first orientation components for the first transformation based on the updated second orientation components and the updated third orientation components.

The calibration apparatus 110 and/or the processing unit 901 and/or the estimating unit 920 is configured for estimating initial translation components for the first transformation based on the updated second translation components.

The calibration apparatus 110 and/or the processing unit 901 and/or the determining unit 930 is configured for iteratively determining at least updated orientation components for the first transformation and a further updated second focal length under a first constraint that a first reprojection error for at least one reprojection point in the first and second fields of view satisfies a first condition for allowed reprojection error.

The calibration apparatus 110 and/or the processing unit 901 and/or the obtaining unit 910 may be configured for obtaining a set of measures comprising at least five of:
the first measure A′R,
the second measure A′L,
the third measure A′B′,
the fourth measure B′R,
the fifth measure B′L, or
the sixth measure RL,
   wherein when the set of measures comprises all but one measure of the first, second, third, fourth, fifth and sixth measures, the calibration apparatus 110 and/or the processing unit 901 and/or the calculating unit 960 may be configured for calculating said one measure based on the set of measures.

The calibration apparatus 110 and/or the processing unit 901 and/or the obtaining unit 910 may be configured for obtaining the seventh measure, the first angle measure vA, the second angle measure vB, and the third angle measure vC.

The calibration apparatus 110 and/or the processing unit 901 and/or the obtaining unit 910 may be configured for obtaining the object distance D.

The calibration apparatus 110 and/or the processing unit 901 and/or the determining unit 930 may be configured for iteratively determining the updated orientation components of the third transformation TAC and the updated third focal length by solving a third mathematical equation system dependent on the orientation components, and optionally translation components, of the third transformation and the third focal length while satisfying the third constraint, thereby obtaining the updated orientation components for the third transformation and the updated third focal length.

The calibration apparatus 110 and/or the processing unit 901 and/or the determining unit 930 may be configured for iteratively determining the updated orientation and translation components for the second transformation and the updated second focal length by solving a second mathematical equation system dependent on the orientation and translation components of the second transformation and the second focal length while satisfying the second constraint, thereby obtaining the updated orientation and translation components for the second transformation and the updated second focal length.

The calibration apparatus 110 and/or the processing unit 901 and/or the determining unit 930 may be configured for iteratively determining said at least updated orientation components for the first transformation and the further updated second focal length by solving a first mathematical equation system dependent on the orientation and translation components of the first transformation and the second focal length while satisfying the first constraint, thereby obtaining said at least updated orientation components for the first transformation and the further updated second focal length.

The calibration apparatus 110 and/or the processing unit 901 and/or the receiving unit 940 may be configured for receiving, from the first camera A, a tracking stream relating to a tracked object 120. The tracking stream includes information for generating a tracking trace. The tracking stream can include one or more of image frames captured by the first camera A, tracking data, blob information, paths, tracks or the like.

The calibration apparatus 110 and/or the processing unit 901 and/or the receiving unit 940 may be configured for receiving a video stream from the second camera B.

The calibration apparatus 110 and/or the processing unit 901 and/or the rendering unit 950 may be configured for rendering the tracking trace relating to the tracked object 120 in the video stream based on the tracking stream, while using the first transformation.

The calibration apparatus 110 and/or the processing unit 901 and/or the calculating unit 960 may be configured for calculating a two-dimensional sensor size of the first, second and third camera, respectively, based on the image resolution of the first, second and third camera, respectively, and/or

the calibration apparatus 110 and/or the processing unit 901 and/or the calculating unit 960 may be configured for calculating an aspect ratio of images captured by the first, second and third camera, respectively, based on the image resolution of the first, second and third camera, respectively.

The calibration apparatus 110 and/or the processing unit 901 and/or the obtaining unit 910 may be configured for obtaining the first focal length of the first camera A.

In the examples above, any one of the units may include one or more further units, or may be separated into multiple units. E.g., “the estimating unit” can refer to the aforementioned estimating unit or one or more further estimating units (not shown), etc. for any one of the further units mentioned, implicitly or explicitly herein.

As used herein, the term “unit” may refer to one or more functional units, each of which may be implemented as one or more hardware units and/or one or more software units and/or a combined software/hardware unit in a node. In some examples, the unit may represent a functional unit realized as software and/or hardware of the node.

As used herein, the term “computer program carrier”, “program carrier”, or “carrier”, may refer to one of an electronic signal, an optical signal, a radio signal, and a computer readable medium. In some examples, the computer program carrier may exclude transitory, propagating signals, such as the electronic, optical and/or radio signal. Thus, in these examples, the computer program carrier may be a non-transitory carrier, such as a non-transitory computer readable medium.

As used herein, the term “processing unit” can include one or more hardware units, one or more software units or a combination thereof.

As used herein, the term “software unit” may refer to a software application, a Dynamic Link Library (DLL), a software component, a software module, a software object, a React component, an object according to Component Object Model (COM), a software function, a software engine, an executable binary software file or the like.

The terms “processing unit” or “processing circuit” may herein comprise one or more processors, an Application Specific Integrated Circuit (ASIC), a Field-Programmable Gate Array (FPGA) or the like. The processing circuit or the like may comprise one or more processor kernels.

As used herein, the expression “configured to/for” may mean that a processing circuit is configured to, such as adapted to or operative to, by means of software configuration and/or hardware configuration, perform one or more of the actions described herein.

As used herein, the term “action” may refer to an action, a step, an operation, a response, a reaction, an activity or the like. It shall be noted that an action herein may be split into two or more sub-actions as applicable. Moreover, also as applicable, it shall be noted that two or more of the actions described herein may be merged into a single action.

As used herein, the term “memory” may refer to a hard disk, a magnetic storage medium, a portable computer diskette or disc, flash memory, random access memory (RAM) or the like. Furthermore, the term “memory” may refer to an internal register memory of a processor or the like.

As used herein, the term “computer readable medium” may be a Universal Serial Bus (USB) memory, a Digital Versatile Disc (DVD), a Blu-ray disc, a software unit that is received as a stream of data, a Flash memory, a hard drive, a memory card, such as a MemoryStick, a Multimedia Card (MMC), Secure Digital (SD) card, etc. One or more of the aforementioned examples of computer readable medium may be provided as one or more computer program products.

As used herein, the term “computer readable code units” may be text of a computer program, parts of or an entire binary file representing a computer program in a compiled format or anything there between.

Any feature disclosed for one example and/or embodiment may be combined with one or more features disclosed for one or more other examples and/or embodiments without departing from the scope herein.

1. A method, performed by a calibration apparatus, for determining a first transformation between a first coordinate system of a first camera and a second coordinate system of a second camera, wherein the first and second cameras are spaced away from each other and located above a ground plane, wherein a first field of view of the first camera at least partially overlaps with a second field of view of the second camera, wherein a third camera has a third field of view partially overlapping with the first and second fields of view, wherein the third camera's position and the first camera's position are approximated to be equal, wherein a distant object is present in the first, second and third fields of view and located at an object distance from a location at at least one of the first camera, the second camera, or the third camera, wherein a first marker and a second marker are located at the ground plane and the first and second markers are visible in the second and third fields of view, wherein a second transformation is between the second coordinate system of the second camera and a third coordinate system of the third camera, wherein a third transformation is between the first coordinate system of the first camera and the third coordinate system of the third camera, wherein the first camera has a first focal length, wherein a first measure indicates a first distance, projected on the ground plane, between the first marker and at least one of the first camera or the third camera, wherein a second measure indicates a second distance, projected on the ground plane, between the second marker and at least one of the first camera or the third camera, wherein a third measure indicates a third distance, projected on the ground plane, between the second camera and at least one of the first camera or the third camera, wherein a fourth measure indicates a fourth distance, projected on the ground plane, between the second camera and the first marker, wherein a fifth measure indicates a fifth distance, projected on the ground plane, between the second camera and the second marker, wherein a sixth measure indicates a sixth distance, projected on the ground plane, between the first marker and the second marker, wherein a seventh measure indicates a seventh distance indicating a difference in height between the second camera and at least one of the first camera or the third camera, wherein a first angle measure indicates a feature angle identified in a first image plane representing the first field of view, wherein a second angle measure indicates the feature angle identified in a second image plane representing the second field of view, wherein a third angle measure indicates the feature angle identified in a third image plane representing the third field of view, wherein the method comprises:
estimating a third focal length of the third camera based on the first measure, the second measure, a third position of the first marker in the third field of view, a fourth position of the second marker in the third field of view, the sixth measure, and an image resolution of the third camera;
estimating initial orientation components of the third transformation based on the distant object's position in the first camera, an image resolution of the first camera, the first focal length, the distant object's position in the third camera, the image resolution of the third camera, the third focal length, the object distance, the first angle measure, and the third angle measure;
estimating initial translation components of the third transformation to be zero;
iteratively determining updated orientation components of the third transformation and an updated third focal length under a third constraint that a third reprojection error for at least one reprojection point in the first and third fields of view satisfies a third condition for allowed reprojection error;
estimating a second focal length of the second camera based on the fourth measure, the fifth measure, a first position of the first marker in the second field of view, a second position of the second marker in the second field of view, the sixth measure, and an image resolution of the second camera;
estimating initial orientation components of the second transformation based on the distant object's position in the second camera, an image resolution of the second camera, the second focal length, the distant object's position in the third camera, an image resolution of the third camera, the third focal length, the object distance, the third measure, the seventh measure, the second angle measure, and the third angle measure;
estimating initial translation components of the second transformation based on the third measure defining a radius of an imaginary circle centered at the second camera, the second measure defining a radius of an imaginary circle centered at the second marker, the fifth measure, and the seventh measure;
iteratively determining updated orientation components and updated translation components for the second transformation and an updated second focal length under a second constraint that a second reprojection error for at least one reprojection point in the second and third fields of view satisfies a second condition for allowed reprojection error;
estimating initial orientation components for the first transformation based on the updated orientation components for the second transformation and the updated orientation components of the third transformation;
estimating initial translation components for the first transformation based on the updated translation components for the second transformation;
iteratively determining at least updated orientation components for the first transformation and a further updated second focal length under a first constraint that a first reprojection error for at least one reprojection point in the first and second fields of view satisfies a first condition for allowed reprojection error.

2. The method according to claim 1, wherein the method comprises:
obtaining a set of measures comprising at least five of the first measure, the second measure, the third measure, the fourth measure, the fifth measure, or the sixth measure, wherein when the set of measures comprises all but one measure of the first, second, third, fourth, fifth and sixth measures, calculating said one measure based on the set of measures; and
obtaining the seventh measure, the first angle measure, the second angle measure, and the third angle measure.

3. The method according to claim 1, wherein the method comprises obtaining the object distance.

4. The method according to claim 1, wherein the iteratively determining of the updated orientation components of the third transformation and the updated third focal length is performed by solving a third mathematical equation system dependent on at least the orientation components of the third transformation and the third focal length while satisfying the third constraint.

5. The method according to claim 4, wherein the iteratively determining of the updated orientation components and the updated translation components for the second transformation and the updated second focal length is performed by solving a second mathematical equation system dependent on the orientation components and the translation components of the second transformation and the second focal length while satisfying the second constraint.

6. The method according to claim 5, wherein the iteratively determining of said at least updated orientation components for the first transformation and the further updated second focal length is performed by solving a first mathematical equation system dependent on orientation and translation components of the first transformation and the second focal length while satisfying the first constraint.

7. The method according to claim 1, wherein the method comprises:
receiving, from the first camera, a tracking stream relating to a tracked object, wherein the tracking stream includes information for generating a tracking trace, wherein the tracking stream can include one or more of image frames captured by the first camera, tracking data, blob information, paths, or tracks;
receiving a video stream from the second camera; and
rendering the tracking trace relating to the tracked object in the video stream based on the tracking stream, while using the first transformation.

8. The method according to claim 1, wherein the method comprises:
calculating a two-dimensional sensor size of the first, second and third camera, respectively, based on the image resolution of the first, second and third camera, respectively; and/or
calculating an aspect ratio of images captured by the first, second and third camera, respectively, based on the image resolution of the first, second and third camera, respectively.

9. The method according to claim 1, wherein the method comprises obtaining the first focal length of the first camera.

10. A system comprising:
a first camera having a first focal length;
a second camera, wherein the first and second cameras are spaced away from each other and located above a ground plane, a first field of view of the first camera at least partially overlaps with a second field of view of the second camera;
a third camera having a third field of view partially overlapping with the first and second fields of view;
wherein the third camera's position and the first camera's position are approximated to be equal, wherein a distant object is present in the first, second and third fields of view and located at an object distance from a location at at least one of the first camera, the second camera, or the third camera, wherein a first marker and a second marker are located at the ground plane and the first and second markers are visible in the second and third fields of view, wherein a second transformation is between a second coordinate system of the second camera and a third coordinate system of the third camera, wherein a third transformation is between a first coordinate system of the first camera and the third coordinate system of the third camera, wherein a first measure indicates a first distance, projected on the ground plane, between the first marker and at least one of the first camera or the third camera, wherein a second measure indicates a second distance, projected on the ground plane, between the second marker and at least one of the first camera or the third camera, wherein a third measure indicates a third distance, projected on the ground plane, between the second camera and at least one of the first camera or the third camera, wherein a fourth measure indicates a fourth distance, projected on the ground plane, between the second camera and the first marker, wherein a fifth measure indicates a fifth distance, projected on the ground plane, between the second camera and the second marker, wherein a sixth measure indicates a sixth distance, projected on the ground plane, between the first marker and the second marker, wherein a seventh measure indicates a seventh distance indicating a difference in height between the second camera and at least one of the first camera or the third camera, wherein a first angle measure indicates a feature angle identified in a first image plane representing the first field of view, wherein a second angle measure indicates the feature angle identified in a second image plane representing the second field of view, wherein a third angle measure indicates the feature angle identified in a third image plane representing the third field of view; and
a calibration apparatus configured to determine a first transformation between the first coordinate system of the first camera and the second coordinate system of the second camera, the calibration apparatus being configured to perform operations comprising:
estimating a third focal length of the third camera based on the first measure, the second measure, a third position of the first marker in the third field of view, a fourth position of the second marker in the third field of view, the sixth measure, and an image resolution of the third camera;
estimating initial orientation components of the third transformation based on the distant object's position in the first camera, an image resolution of the first camera, the first focal length, the distant object's position in the third camera, the image resolution of the third camera, the third focal length, the object distance, the first angle measure, and the third angle measure;
estimating initial translation components of the third transformation to be zero;
iteratively determining updated orientation components of the third transformation and an updated third focal length under a third constraint that a third reprojection error for at least one reprojection point in the first and third fields of view satisfies a third condition for allowed reprojection error;
estimating a second focal length of the second camera based on the fourth measure, the fifth measure, a first position of the first marker in the second field of view, a second position of the second marker in the second field of view, the sixth measure, and an image resolution of the second camera;
estimating initial orientation components of the second transformation based on the distant object's position in the second camera, an image resolution of the second camera, the second focal length, the distant object's position in the third camera, an image resolution of the third camera, the third focal length, the object distance, the third measure, the seventh measure, the second angle measure, and the third angle measure;
estimating initial translation components of the second transformation based on the third measure defining a radius of an imaginary circle centered at the second camera, the second measure defining a radius of an imaginary circle centered at the second marker, the fifth measure, and the seventh measure;
iteratively determining updated orientation components and updated translation components for the second transformation and an updated second focal length under a second constraint that a second reprojection error for at least one reprojection point in the second and third fields of view satisfies a second condition for allowed reprojection error;
estimating initial orientation components for the first transformation based on the updated orientation components for the second transformation and the updated orientation components of the third transformation;
estimating initial translation components for the first transformation based on the updated translation components for the second transformation;
iteratively determining at least updated orientation components for the first transformation and a further updated second focal length under a first constraint that a first reprojection error for at least one reprojection point in the first and second fields of view satisfies a first condition for allowed reprojection error.

11. The system according to claim 10, wherein the operations comprise:
obtaining a set of measures comprising at least five of the first measure, the second measure, the third measure, the fourth measure, the fifth measure, or the sixth measure, wherein when the set of measures comprises all but one measure of the first, second, third, fourth, fifth and sixth measures, calculating said one measure based on the set of measures; and
obtaining the seventh measure, the first angle measure, the second angle measure, and the third angle measure.

12. The system according to claim 10, wherein the operations comprise obtaining the object distance.

13. The system according to claim 10, wherein the iteratively determining of the updated orientation components of the third transformation and the updated third focal length is performed by solving a third mathematical equation system dependent on at least the orientation components of the third transformation and the third focal length while satisfying the third constraint.

14. The system according to claim 10, wherein the iteratively determining of the updated orientation components and the updated translation components for the second transformation and the updated second focal length is performed by solving a second mathematical equation system dependent on the orientation components and the translation components of the second transformation and the second focal length while satisfying the second constraint.

15. The system according to claim 10, wherein the iteratively determining of said at least updated orientation components for the first transformation and the further updated second focal length is performed by solving a first mathematical equation system dependent on orientation and translation components of the first transformation and the second focal length while satisfying the first constraint.

16. The system according to claim 10, wherein the operations comprise:
receiving, from the first camera, a tracking stream relating to a tracked object, wherein the tracking stream includes information for generating a tracking trace, wherein the tracking stream can include one or more of image frames captured by the first camera, tracking data, blob information, paths, or tracks;
receiving a video stream from the second camera; and
rendering the tracking trace relating to the tracked object in the video stream based on the tracking stream, while using the first transformation.

17. The system according to claim 10, wherein the operations comprise:
calculating a two-dimensional sensor size of the first, second and third camera, respectively, based on the image resolution of the first, second and third camera, respectively; and/or
calculating an aspect ratio of images captured by the first, second and third camera, respectively, based on the image resolution of the first, second and third camera, respectively.

18. The system according to claim 10, wherein the operations comprise obtaining the first focal length of the first camera.

19. A non-transitory computer readable medium encoding instructions that, when executed by a calibration apparatus, perform operations comprising determining a first transformation between a first coordinate system of a first camera and a second coordinate system of a second camera, wherein the first and second cameras are spaced away from each other and located above a ground plane, wherein a first field of view of the first camera at least partially overlaps with a second field of view of the second camera, wherein a third camera has a third field of view partially overlapping with the first and second fields of view, wherein the third camera's position and the first camera's position are approximated to be equal, wherein a distant object is present in the first, second and third fields of view and located at an object distance from a location at at least one of the first camera, the second camera, or the third camera, wherein a first marker and a second marker are located at the ground plane and the first and second markers are visible in the second and third fields of view, wherein a second transformation is between the second coordinate system of the second camera and a third coordinate system of the third camera, wherein a third transformation is between the first coordinate system of the first camera and the third coordinate system of the third camera, wherein the first camera has a first focal length, wherein a first measure indicates a first distance, projected on the ground plane, between the first marker and at least one of the first camera or the third camera, wherein a second measure indicates a second distance, projected on the ground plane, between the second marker and at least one of the first camera or the third camera, wherein a third measure indicates a third distance, projected on the ground plane, between the second camera and at least one of the first camera or the third camera, wherein a fourth measure indicates a fourth distance, projected on the ground plane, between the second camera and the first marker, wherein a fifth measure indicates a fifth distance, projected on the ground plane, between the second camera and the second marker, wherein a sixth measure indicates a sixth distance, projected on the ground plane, between the first marker and the second marker, wherein a seventh measure indicates a seventh distance indicating a difference in height between the second camera and at least one of the first camera or the third camera, wherein a first angle measure indicates a feature angle identified in a first image plane representing the first field of view, wherein a second angle measure indicates the feature angle identified in a second image plane representing the second field of view, wherein a third angle measure indicates the feature angle identified in a third image plane representing the third field of view, wherein the operations comprises:
estimating a third focal length of the third camera based on the first measure, the second measure, a third position of the first marker in the third field of view, a fourth position of the second marker in the third field of view, the sixth measure, and an image resolution of the third camera;
estimating initial orientation components of the third transformation based on the distant object's position in the first camera, an image resolution of the first camera, the first focal length, the distant object's position in the third camera, the image resolution of the third camera, the third focal length, the object distance, the first angle measure, and the third angle measure;
estimating initial translation components of the third transformation to be zero;
iteratively determining updated orientation components of the third transformation and an updated third focal length under a third constraint that a third reprojection error for at least one reprojection point in the first and third fields of view satisfies a third condition for allowed reprojection error;
estimating a second focal length of the second camera based on the fourth measure, the fifth measure, a first position of the first marker in the second field of view, a second position of the second marker in the second field of view, the sixth measure, and an image resolution of the second camera;
estimating initial orientation components of the second transformation based on the distant object's position in the second camera, an image resolution of the second camera, the second focal length, the distant object's position in the third camera, an image resolution of the third camera, the third focal length, the object distance, the third measure, the seventh measure, the second angle measure, and the third angle measure;
estimating initial translation components of the second transformation based on the third measure defining a radius of an imaginary circle centered at the second camera, the second measure defining a radius of an imaginary circle centered at the second marker, the fifth measure, and the seventh measure;
iteratively determining updated orientation components and updated translation components for the second transformation and an updated second focal length under a second constraint that a second reprojection error for at least one reprojection point in the second and third fields of view satisfies a second condition for allowed reprojection error;
estimating initial orientation components for the first transformation based on the updated orientation components for the second transformation and the updated orientation components of the third transformation;
estimating initial translation components for the first transformation based on the updated translation components for the second transformation;
iteratively determining at least updated orientation components for the first transformation and a further updated second focal length under a first constraint that a first reprojection error for at least one reprojection point in the first and second fields of view satisfies a first condition for allowed reprojection error.

20. The non-transitory computer readable medium according to claim 19, wherein the operations comprise:
obtaining a set of measures comprising at least five of the first measure, the second measure, the third measure, the fourth measure, the fifth measure, or the sixth measure, wherein when the set of measures comprises all but one measure of the first, second, third, fourth, fifth and sixth measures, calculating said one measure based on the set of measures; and
obtaining the seventh measure, the first angle measure, the second angle measure, and the third angle measure.
